(19) United States
(12) Patent Application Publication
(10) Pub. No.: US 2025/0160341 A1
(43) Pub. Date: May 22, 2025

(54) Reduced or Zero Added Sodium Snack Food Pellets

(71) Applicant: Frito-Lay Trading Company GmbH, Bern (CH)

(72) Inventors: Rachel Emily Duckworth, Bern (CH); David Paul Jones, Bern (CH); Bhavnita Patel, Bern (CH); Roshni Patel, Bern (CH); Monica Talsania, Bern (CH); Alan John Stannard, Bern (CH); Amrit Kaur Tara, Bern (CH)

(21) Appl. No.: 18/729,602

(22) PCT Filed: Feb. 1, 2023
(86) PCT No.: PCT/IB2023/050881

§ 371 Date: Jul. 17, 2024

(30) Foreign Application Priority Data
Feb. 7, 2022 (GB) 2201543.2

(51) Int. Cl. A21D 2/02; A21D 2/14; A23L 7/17

(52) U.S. Cl. CPC A21D 2/02; A21D 2/145; A23L 7/17

(57) ABSTRACT

Methods for manufacturing reduced or zero added sodium expandable snack food pellets by including a functional ingredient to increase the expansion ratio of the pellets. Methods for manufacturing reduced or zero added sodium expandable snack food pellets by including a functional ingredient to decrease the glass transition temperature of the pellets. Methods for manufacturing reduced or zero added sodium expandable snack food by including a functional ingredient to decrease the bulk density of the snack food. Reduced or zero added sodium expandable snack food pellets having specific expansion ratio and/or glass transition temperature, and reduced or zero added sodium expanded snack food products prepared from the pellets. Reduced or zero added sodium expanded snack food having specific bulk density.

### FIELD OF THE INVENTION

The present invention relates to a reduced added sodium or zero added sodium snack food pellet for manufacturing an expanded snack food, a reduced added sodium or zero added sodium expanded snack food, and a method of manufacturing a reduced added sodium or zero added sodium expandable snack food pellet.

### BACKGROUND AND PRIOR ART

The use of snack food pellets to produce snack food products is known. The pellets may be produced by extrusion and, upon cooking, the pellets may expand to produce an expanded snack food.

Known snack food pellets typically include a high amount of added sodium. The sodium content of some known pellet compositions is 1-4 wt. %, which may come from sources such as sodium chloride, sodium bicarbonate and/or monosodium glutamate. For example, where the sodium source is sodium chloride, 2.4 wt. %, sodium chloride equates to around 950 mg of sodium per 100 g of pellets. The amount of added sodium can vary between products. For example, expanded cereal snacks, such as Sabritones™ typically comprise 1445 mg of added sodium per 100 g of Sabritones™, whereas Bugles™ typically comprise 450-500 mg of added sodium per 100 g of Bugles™. Expanded potato based snacks, such as Quavers™, typically comprise 654 mg of added sodium per 100 g of Quavers™.

Added sodium is important in snack food pellets as it enables the formation of an expanded snack food product with a texture that is desirable to consumers. It is thought that the added sodium plays an important role in the expansion of snack food pellets. In addition, added sodium imparts a taste to the expanded snack food product which is desirable to consumers.

However, too much dietary sodium is not healthy and it is therefore desirable to produce lower sodium food products, especially snack food products. Ideally, the amount of sodium should be reduced to less than 300 mg of added sodium per 100 g of pellets and, more preferably, to zero added sodium.

However, it is not straightforward to remove sodium from expanded snack food pellets. Due to the role that sodium plays in expansion, if sodium is simply removed, the pellet tends to suffer from a high glass transition temperature and/or low or minimal expansion which leads to expanded products with high bulk density which may exhibit unexpanded glassy phases. Such products are undesirable to consumers.

Attempts have been made to compensate for the effect that added sodium has on pellet expansion by altering the composition of the starch matrix. For example, WO2015/118060 discloses adjusting the ratio of crystalline fraction to amorphous fraction in the starch matrix by adding in more amorphous starch to the starch composition such that the matrix has a higher concentration of amorphous starch which provides a starch mobility and water mobility in the amorphous regions which has a similar effect to the starch disruption provided by sodium and could therefore achieve comparable expansion.

However, such an approach involves adding in large quantities of expensive functional starches such as N-Hance 59 which makes the method cost prohibitive. Therefore, what is needed is a method of compensating for the effects of sodium on expansion which can be readily applied to existing manufacturing methods in a cost effective, preferably cost neutral, manner.

### SUMMARY

In a first aspect, the invention provides a method for manufacturing a reduced or zero added sodium expandable snack food pellet comprising providing a dough comprising less than about 300 mg of added sodium per 100 g of dough and a functional ingredient; extruding the dough through an extruder to produce an extrudate; forming the extrudate into pellets; and drying the pellets; wherein the functional ingredient increases an expansion ratio of the pellet by about 5% to about 40% relative to an identical pellet manufactured from a dough which does not comprise the functional ingredient.

In a second aspect, the invention provides a method for manufacturing a reduced or zero added sodium expandable snack food pellet comprising: providing a dough comprising less than about 300 mg of added sodium per 100 g of dough and a functional ingredient; extruding the dough through an extruder to produce an extrudate; forming the extrudate into pellets; and drying the pellets; wherein the functional ingredient decreases a glass transition temperature of the pellet by about 5% to about 35% relative to an identical pellet manufactured from a dough which does not comprise the functional ingredient.

In a third aspect, the invention provides a method for manufacturing a reduced or zero added sodium expanded snack food comprising: providing a dough comprising less than about 300 mg of added sodium per 100 g of dough and a functional ingredient; extruding the dough through an extruder to produce an extrudate; forming the extrudate into pellets; drying the pellets; and cooking the pellets; wherein the functional ingredient decreases a bulk density of the snack food by about 5% to about 35% relative to an identical snack food manufactured from a dough which does not comprise the functional ingredient.

In some embodiments, the functional ingredient is selected from the group consisting of pre-gelatinised starches, raising agents, acids, matrix modifiers, alternative salts, and combinations thereof.

In some embodiments, the dough comprises about 2 wt % to 8 wt % of pre-gelatinised starch, preferably wherein the pre-gelatinised starch is a pre-gelatinised rice flour.

In some embodiments, the dough comprises about 0.2 wt % to 1.0 wt % of acid, preferably wherein the acid is monocalcium phosphate and/or citric acid.

In some embodiments, the dough comprises about 1 wt % to 10% of matrix modifier, preferably wherein the matrix modifier is sugar. In some embodiments, the dough comprises about 0.1 wt % to 2.5 wt % raising agent, preferably wherein the raising agent is sodium bicarbonate.

In some embodiments, the alternative salt is selected from the group consisting of potassium chloride, magnesium chloride, potassium sulphate, sodium acetate, tetrasodium pyrophosphate, and combinations thereof.

In some embodiments, the functional ingredient comprises an acid and a raising agent, preferably at a ratio of about 1:2.0 to 1:3.0, more preferably about 1:2.5.

In some embodiments, the dough comprises less than about 250 mg, preferably 200 mg, more preferably 150 mg of added sodium per 100 g of dough. In some embodiments, the dough comprises zero added sodium per 100 g of dough.

In a fourth aspect, the invention provides a method for manufacturing a reduced or zero added sodium expandable snack food pellet comprising: providing a dough comprising less than about 300 mg of added sodium per 100 g of dough and a functional ingredient; extruding the dough through an extruder to produce an extrudate; forming the extrudate into pellets; and drying the pellets; wherein the pellet has an expansion ratio which is about ±10%, preferably ±5%, of the expansion ratio of a standard pellet not comprising the functional ingredient.

In a fifth aspect, there is provided a method for manufacturing a reduced or zero added sodium expandable snack food pellet comprising: providing a dough comprising less than about 300 mg of added sodium per 100 g of dough and a functional ingredient; extruding the dough through an extruder to produce an extrudate; forming the extrudate into pellets; and drying the pellets; wherein the pellet has a glass transition temperature which is about ±10%, preferably ±5%, of the glass transition temperature of a standard pellet not comprising the functional ingredient.

In a sixth aspect, there is provided a reduced or zero added sodium expandable snack food pellet manufactured by the method of any one of the first, second, fourth or fifth aspects.

In a seventh aspect, there is provided a reduced or zero added sodium expandable snack food pellet comprising less than about 300 mg added sodium per 100 g of pellets and a functional ingredient, wherein the pellet has a glass transition temperature of less than about 80° C., preferably less than about 75° C., more preferably, less than about 70° C.

In an eighth aspect, there is provided a reduced or zero added sodium expandable snack food pellet comprising less than about 300 mg added sodium per 100 g of pellets and a functional ingredient, wherein the pellet has an expansion ratio which is about ±5% of the expansion ratio of a standard pellet not comprising the functional ingredient.

In a ninth aspect, there is provided an expanded snack food manufactured from the reduced or zero added sodium expandable snack food pellet according to any one of the sixth, seventh or eighth aspects.

In a tenth aspect, there is provided a method for manufacturing a reduced or zero added sodium expanded snack food comprising: providing a dough comprising less than about 300 mg of added sodium per 100 g of dough and a functional ingredient; extruding the dough through an extruder to produce an extrudate; forming the extrudate into pellets; drying the pellets; and cooking the pellets; wherein the snack food has a bulk density which is about ±5% of the bulk density of a standard snack food not comprising the functional ingredient.

In an eleventh aspect, there is provided a method of manufacturing a reduced or zero added sodium expanded snack food, comprising: providing a plurality of reduced or zero added sodium snack food pellets according to any one of aspects 6 to 9; and expanding the pellets during a cooking step to produce an expanded snack food; optionally wherein the cooking step comprises frying, baking, microwaving or popping.

In a twelfth aspect, there is provided a reduced or zero added sodium expanded snack food comprising less than about 300 mg added sodium per 100 g of snack food and a functional ingredient, wherein the snack food has a bulk density which is about ±5% of the bulk density of a standard snack food not comprising the functional ingredient.

In a thirteenth aspect, there is provided a reduced or zero added sodium expanded snack food manufactured by the method of any one of the third, tenth or eleventh aspects.

The present invention thus provides a method for manufacturing a reduced or zero added sodium expandable snack food pellet and a method for manufacturing a reduced or zero added sodium expanded snack food.

All percentages recited in the following description and claims refer to a percent by weight unless expressly stated otherwise.

### BRIEF DESCRIPTION OF THE FIGURES

FIG. 1 is a graph showing the impact of a pre-gelatinised functional ingredient on the bulk density of potato based expanded snack food products.

FIG. 2 is a graph showing the impact of a pre-gelatinised functional ingredient on the glass transition temperature of potato based pellets.

FIG. 3 is a graph showing the impact of a pre-gelatinised functional ingredient on the expansion ratio of pellets.

FIG. 4 is a graph showing the impact of an acid and raising agent functional ingredient on the bulk density of wheat-based expanded snack food products.

FIG. 5 is a graph showing the impact of an acid and raising agent functional ingredient on the bulk density of maize-based expanded snack food products.

FIG. 6 is a graph showing the impact of a sugar functional ingredient on the glass transition temperature of potato based pellets.

FIG. 7 is a graph showing the impact of a sugar functional ingredient on cell size of potato based expanded snack food products.

FIG. 8 are SEM micrographs showing the impact of a sugar functional ingredient on cell size of potato based expanded snack food products.

### DETAILED DESCRIPTION

### Definitions

As used herein, the term “functional ingredient” means a material that is added to a dough for a particular purpose or to ensure a desired attribute in the final product. Such materials are usually added in small quantities. Examples of these functional ingredients include the ingredients discussed in this disclosure, but can also include ingredients like calcium chloride (for acrylamide mitigation), antioxidant (preservative), yeast powder (flavour), and emulsifier (processing aid).

By including a functional ingredient in a pellet dough, the expansion ratio of a reduced or zero added sodium snack food pellet may be increased by about 5% to about 40% relative to the same pellet manufactured from a dough which does not comprise the functional ingredient. In some embodiments, the expansion ratio may be increased by about 10% to about 35%, or about 15% to about 30%. In some embodiments, inclusion of a functional ingredient in the dough may increase the expansion ratio of the pellet by about 20% relative to the same pellet manufactured from a dough which does not comprise the functional ingredient.

In some embodiments, inclusion of a functional ingredient in the dough provides a reduced or zero added sodium expandable snack food pellet having an expansion ratio which is about ±10%, preferably ±5%, of the expansion ratio of a standard pellet not comprising the functional ingredient.

As used herein, the term “expansion ratio” is the volume ratio between the dried pellet and the expanded snack food. The expansion ratio can be determined by volumetric (displacement) measurement. In the present disclosure, where a comparison is made between the expansion ratio of a reduced or zero added sodium snack food pellet according to the present disclosure and the same pellet manufactured under standard conditions, the same conditions are used to expand the pellets to produce an expanded snack food.

Alternatively or additionally, the inclusion of a functional ingredient in the dough may have the effect of decreasing the glass transition temperature of the pellet by about 5% to about 35% relative to the same pellet manufactured from a dough which does not comprise the functional ingredient. In some embodiments, the glass transition temperature may be decreased by about 10% to about 30%, or about 15% to about 25%. In some embodiments, inclusion of a functional ingredient in the dough may decrease the glass transition temperature of the pellet by about 20% relative to the same pellet manufactured from a dough which does not comprise the functional ingredient.

In some embodiments, inclusion of a functional ingredient in the dough provides a reduced or zero added sodium expandable snack food pellet having a glass transition temperature which is about ±10%, preferably ±5%, of the glass transition temperature of a standard pellet not comprising the functional ingredient.

As used herein, the term “glass transition temperature” is the temperature at which the material begins to demonstrate flow, or where a plastic flexible material is beginning to acquire more solid like behaviour.

By including a functional ingredient in a pellet dough, the bulk density of a reduced or zero added sodium expanded snack food may be decreased by about 5% to about 35% relative to the same reduced or zero added sodium snack food manufactured from a dough which does not comprise the functional ingredient. In some embodiments, the bulk density may be decreased by about 10% to about 30% relative to the same snack food manufactured from a dough which does not comprise the functional ingredient. In some embodiments, including a functional ingredient in the dough decreases the bulk density of the resulting expanded snack food product by about 20% relative to the same snack food manufactured from a dough which does not comprise the functional ingredient.

Alternatively or additionally, the inclusion of a functional ingredient may have the effect of providing a reduced or zero added sodium expanded snack food having a bulk density which is about ±10%, preferably ±5% of the bulk density of a standard snack food not comprising the functional ingredient.

As used herein, the term “bulk density” means the mass of the material divided by the total volume that it occupies.

It is thought that the decrease in glass transition temperature of pellets formed from the dough comprising a functional ingredient enables the pellets to start expanding at lower temperatures, enabling greater expansion and a greater expansion ratio compared to reduced or zero sodium pellets without the functional ingredient at the same frying conditions. This in turn then produces expanded snack food products with decreased bulk density and, consequently, improved texture. This was unexpected because, as discussed further below, adding in new ingredients to pellet doughs generally changes the textural properties of the resulting expanded snack food products and often results in a product which is unrecognisable from the same products which do not contain the additional ingredient(s).

The increased expansion ratio of the snack food pellet results in expansion of the pellet during cooking in a comparable way to a standard added sodium pellet. In addition, the resultant snack food has a desirable bulk density. The present invention thus allows manufacture of an expanded snack food product which has reduced or zero added sodium but which has a texture comparable to a comparable standard added sodium expanded snack food product.

Throughout the present disclosure, the term “at least” includes the start point of the range.

Throughout the present disclosure, the term “same pellet” or “an identical pellet” means a pellet which has the same composition as the reference pellet but does not comprise the functional ingredient. The term “same snack food” or “an identical snack food” means a snack food which has the same composition as the reference snack food but which does not comprise the functional ingredient.

Throughout the present disclosure, the term “standard conditions” means the conditions used to manufacture a comparable standard added sodium pellet or a comparable standard added sodium expanded snack food.

Throughout the present disclosure, the term “comparable pellet” means a pellet which, with the exception of the amount of added sodium, has the same composition as the reference pellet. The term “comparable snack food” means a snack food which, with the exception of the amount of added sodium, has the same composition as the reference snack food.

As an example, the snack food product Sabritones™ is produced from a pellet comprising 1455 mg sodium per 100 g of Sabritones™ (a “standard added sodium pellet” for Sabritones™). The inclusion of a functional ingredient in the dough for a zero added sodium pellet for Sabritones™ produces a pellet which has about a 5% to about 40% increased expansion ratio relative to the same pellet (a “zero added sodium pellet” for Sabritones™) which is manufactured from a dough which does not comprise the functional ingredient.

The term ‘zero added sodium’ means that there has been no sodium added to the pellet or dough. The pellet/dough may contain trace amounts of sodium that are naturally present in the ingredients of the dough, for example, potato flakes typically comprise about 80 mg sodium per 100 g; potato starch typically comprises about 16 mg sodium per 100 g; and cereal flours typically comprise about 5-20 mg sodium per 100 g.

The term ‘zero added sodium’ means that there has been no sodium added to the pellet or dough used to manufacture the snack food. The snack food may contain trace amounts of sodium that are naturally present in the ingredients of the dough, as outlined above.

Expandable snack food pellets are pellets which expand upon cooking to form an expanded snack food of a desired shape and configuration. Various compositions of snack food pellets are known in the art. Typically, snack food pellets are produced by an extrusion process with a subsequent drying step. Cooking typically involves frying the pellets in oil.

### Sodium

Known snack food pellets typically include added sodium to ensure that the pellets have good expansion when cooked, resulting in a snack food with a light and highly porous structure.

Sodium may be present in the pellets, dough used to manufacture the pellets, and/or in the final expanded snack food product in any form suitable for use in consumable food products. References herein to “added sodium” mean any sodium that has been added to the dough or pellets, i.e. sodium that is added beyond sodium that is naturally present in the ingredients of the dough/pellet. Sodium that is naturally present in the ingredients of the dough may be referred to herein as “trace sodium”. Examples of added sodium include sodium chloride, sodium bicarbonate and/or monosodium glutamate. Typically, the added sodium is sodium chloride and/or sodium bicarbonate. Added sodium may also include sodium chloride present in flavoured salts such as onion salt and/or celery salt. When an amount of sodium is referred to in this disclosure, it refers to the total amount of added sodium from all sources of added sodium.

Traditionally, pellets comprise 1.0-3.5 wt % added sodium which may come from sources such as sodium chloride, sodium bicarbonate and/or monosodium glutamate. This is approximately equivalent to 425 mg-2975 mg of added sodium per 100 g of pellet. Such pellets are referred to herein as “standard added sodium pellets” or “standard pellets”.

Similarly, in a method for manufacturing an expandable snack food pellet, the dough used to manufacture the pellet typically comprises 1.0-3.5 wt % added sodium (425 mg-2975 mg per 100 g of pellet). Such doughs are referred to herein as “standard added sodium dough” or “standard dough”. Consequently, an expanded snack food produced from a standard pellet or standard dough typically comprises 1.0-3.5 wt % added sodium (425 mg-2975 mg per 100 g of expanded snack food product). Such a snack food is referred to herein as “standard added sodium expanded sodium snack food” or “standard expanded snack food”.

Reduced added sodium pellets according to the present disclosure comprise or contain less than about 300 mg of added sodium per 100 g of pellet (by dry weight). Preferably, the pellets comprise or contain less than about 275 mg, less than about 250 mg, less than about 225 mg, less than about 200 mg, less than about 175 mg, less than about 150 mg, less than about 125 mg, less than about 100 mg, less than about 75 mg, less than about 50 mg, or less than about 25 mg of added sodium per 100 g of pellet.

Alternatively, reduced added sodium pellets according to the present disclosure comprise or contain up to about 300 mg of added sodium per 100 g of pellet (by dry weight). Preferably, the pellets comprise or contain up to about 275 mg, up to about 250 mg, up to about 225 mg, up to about 200 mg, up to about 175 mg, up to about 150 mg, up to about 125 mg, up to about 100 mg, up to about 75 mg, up to about 50 mg, or up to about 25 mg of added sodium per 100 g of pellet.

Alternatively, reduced added sodium pellets according to the present disclosure comprise or contain between about 0 mg and 300 mg of added sodium per 100 g of pellet (by dry weight). For example, the pellets may comprise or contain between about 25 mg and 275 mg, or between about 50 mg and about 250 mg, or between about 75 mg and 225 mg, or between about 100 mg and about 200 mg, or between about 125 mg and 175 mg of added sodium per 100 g of pellet.

Reduced added sodium expanded snack food according to the present disclosure comprises or contains less than about 300 mg of added sodium per 100 g of snack food (by dry weight). Preferably, the snack food comprises or contains less than about 275 mg, less than about 250 mg, less than about 225 mg, less than about 200 mg, less than about 175 mg, less than about 150 mg, less than about 125 mg, less than about 100 mg, less than about 75 mg, less than about 50 mg, or less than about 25 mg of added sodium per 100 g of snack food.

Alternatively reduced added sodium expanded snack food according to the present disclosure comprises or contains up to about 300 mg of added sodium per 100 g of snack food (by dry weight). Preferably, the snack food comprises or contains up to about 275 mg, up to about 250 mg, up to about 225 mg, up to about 200 mg, up to about 175 mg, up to about 150 mg, up to about 125 mg, up to about 100 mg, up to about 75 mg, up to about 50 mg, or up to about 25 mg of added sodium per 100 g of snack food.

Alternatively, reduced added sodium expanded snack food according to the present disclosure comprise or contain between about 0 mg and 300 mg of added sodium per 100 g of snack food (by dry weight). For example, the snack food may comprise or contain between about 25 mg and 275 mg, or between about 50 mg and about 250 mg, or between about 75 mg and 225 mg, or between about 100 mg and about 200 mg, or between about 125 mg and 175 mg of added sodium per 100 g of snack food.

300 mg of added sodium per 100 g of pellet, dough or expanded snack food product is approximately equivalent to 0.30 wt % (by dry weight). Therefore, in some embodiments, the reduced added sodium pellets comprise or contain less than about 0.30 wt % of added sodium by (dry) weight of the pellet. Preferably, the pellets comprise or contain less than about 0.275 wt %, less than about 0.25 wt %, less than about 0.225 wt %, less than about 0.2 wt %, less than about 0.175 wt %, less than about 0.15 wt %, less than about 0.125 wt %, less than about 0.10 wt %, less than about 0.075 wt %, less than about 0.05 wt %, or less than about 0.025 wt % of added sodium by (dry) weight of the pellet.

In some embodiments, the reduced added sodium expanded snack food product comprises or contains less than about 0.30 wt % of added sodium by (dry) weight of the snack food. Preferably, the snack food comprises or contains less than about 0.275 wt %, less than about 0.25 wt %, less than about 0.225 wt %, less than about 0.2 wt %, less than about 0.175 wt %, less than about 0.15 wt %, less than about 0.125 wt %, less than about 0.10 wt %, less than about 0.075 wt %, less than about 0.05 wt %, or less than about 0.025 wt % of added sodium by (dry) weight of the snack food.

Alternatively, the reduced added sodium pellets comprise or contain up to about 0.30 wt % of added sodium by (dry) weight of the pellet. Preferably, the pellets comprise or contain up to about 0.275 wt %, up to about 0.25 wt %, up to about 0.225 wt %, up to about 0.20 wt %, up to about 0.175 wt %, up to about 0.15 wt %, up to about 0.125 wt %, up to about 0.1 wt %, up to about 0.075 wt %, up to about 0.05 wt %, or up to about 0.025 wt % of added sodium by (dry) weight of the pellet.

In some embodiments, the reduced added sodium expanded snack food product comprises or contains up to about 0.30 wt % of added sodium by (dry) weight of the snack food. Preferably, the snack food comprises or contains up to about 0.275 wt %, about 0.25 wt %, about 0.225 wt %, about 0.20 wt %, about 0.175 wt %, about 0.15 wt %, about 0.125 wt %, about 0.1 wt %, about 0.075 wt %, about 0.05 wt %, or about 0.025 wt % of added sodium by (dry) weight of the snack food.

Alternatively, the reduced added sodium pellets (or reduced added sodium expanded snack food) comprise or contain between about 0 wt % and 0.30 wt % of added sodium by (dry) weight of the pellet. For example, the pellets may comprise or contain between about 0.025 wt % and 0.275 wt %, or between about 0.05 wt % and about 0.25 wt %, or between about 0.075 wt % and 0.225 wt %, or between about 0.1 wt % and about 0.2 wt %, of added sodium by (dry)weight of the pellet.

In some embodiments, the reduced added sodium expanded snack food product comprises or contains between about 0 wt % and 0.30 wt % of added sodium by (dry) weight of the snack food. For example, the snack food may comprise or contain between about 0.025 wt % and 0.275 wt %, or between about 0.05 wt % and about 0.25 wt %, or between about 0.075 wt % and 0.225 wt %, or between about 0.1 wt % and about 0.2 wt %, of added sodium by (dry) weight of the snack food.

In some embodiments, the snack food pellet is referred to as a zero added sodium snack food pellet.

In some embodiments, the snack food is referred to as a zero added sodium snack food.

The present invention is at least partly predicated on the finding by the present inventors that when added sodium is present in a snack food pellet, the sodium plays an essential role in the expansion mechanism of the pellets during cooking. It is thought that the added sodium may have several roles, including modifying the moisture distribution, holding on to water within the pellet, lowering the glass transition temperature (T_{g}), acting as nucleation sites for expansion, increasing the expansion ratio and/or modifying the rheological properties of the matrix. This decreases the bulk density of the expanded snack food product in comparison to a reduced or zero added sodium expanded snack food.

When added sodium is not present in a pellet, moisture is not distributed in the pellet in the same way, the glass transition temperature increases and the rheological strength of the matrix increases. In addition, the expansion ratio of the pellet decreases. This leads to a pellet that, when cooked, has poor expansion, a high bulk density and a texture that is undesirable to consumers—hard, crunchy and dense.

The inventors have surprisingly found that the effect of the absence or reduction of added sodium on expansion ratio and/or bulk density and/or glass transition temperature can be mitigated in a reduced or zero added sodium pellet and/or expanded snack food by including a functional ingredient in the dough.

### Dough Ingredients

The dough used in the present invention may be any dough used to prepare expanded snack food products, with the exception that the amount of added sodium is reduced or eliminated.

Typically, pellets are made from dough comprising starch. The starch component of the dough is the component that expands to the greatest extent to form the expanded snack food product. The starch component is therefore the component that is primarily affected by reducing or eliminating the amount of added sodium.

Any starch based ingredients suitable for forming pellets may be used in the present disclosure. The starch based ingredients may be, for example, potato, grain, legume (pulse) and/or root vegetable. If the starch based ingredient is potato, the ingredient may be in the form of potato dehydrates (e.g. native potato, potato flakes, potato isolates (fiber and protein) and/or potato granules), and/or potato starch. Where the starch based ingredient is a grain, the ingredient may be, for example, wheat, oat, rice (e.g. black rice, red rice), rye, barley, millet, quinoa, triticale, sorghum (e.g. white sorghum) or corn (maize), or a combination thereof. Where the starch based ingredient is a legume, the ingredient may be, for example, chickpea, pea (e.g. green pea, yellow pea), bean (e.g. black bean, green bean, soy bean etc), lentil (e.g. brown lentils, green lentils, red lentil, yellow lentils, black beluga lentils, puy lentils etc), flax seed, or a combination thereof. If the starch is a root vegetable, the ingredient may be cassava. The starch may also, or additionally, be tapioca starch. The starch may also, or additionally be protein isolates (e.g. pea protein isolate),

The dough may include additional ingredients such as fillers (e.g. rice flour) flavours (e.g. yeast powder, onion powder), colours (e.g. annatto, curcumin), and/or fats (e.g. oil).

In a typical wheat-based dough used to manufacture a reduced added sodium pellet, the dough may comprise 98-99.5 wt % wheat flour, 0.1-1.0 wt % sodium chloride, 0-1.0 wt % sodium bicarbonate and 0-1.0 wt % other ingredients (fillers, flavours, colours, potassium bicarbonate, potassium chloride, citric acid and/or oil). Preferably, in a wheat-based dough, the dough comprises around 0.55 wt % sodium chloride and around 0.15 wt % sodium bicarbonate. In a typical wheat-based dough used to produce a zero added sodium pellet, the dough may comprise 99.8-100 wt % wheat flour and 0-0.2 wt % other ingredients such as colourings.

In a typical maize (corn) based dough used to manufacture a reduced added sodium pellet, the dough may comprise 98-99.5 wt % maize flour, 0.1-1.0 wt % sodium chloride, 0-1.0 wt % sodium bicarbonate and 0-1.0 wt % other ingredients (fillers, flavours, colours, potassium bicarbonate, potassium chloride, citric acid and/or oil). Preferably, in a maize-based dough, the dough comprises around 0.55 wt % sodium chloride and around 0.15 wt % sodium bicarbonate. In a typical maize-based dough used to produce a zero added sodium pellet, the dough may comprise 99.8-100 wt % maize flour and 0-0.2 wt % other ingredients such as colourings.

In a typical potato-based dough used to manufacture a reduced or zero added sodium pellet, the dough may comprise 10-97 wt % potato dehydrates (potato flakes and/or potato granules), 10-97 wt % potato starch, 0-1 wt % sodium chloride, 0-1.0 wt % sodium bicarbonate and 0-1.0 wt % other ingredients (fillers, flavours, colours, potassium bicarbonate, potassium chloride, citric acid and/or oil). Preferably, in a potato-based dough, the dough comprises at least 80 wt % potato based starch, around 0.55 wt % sodium chloride and around 0.15 wt % sodium bicarbonate. In a preferred recipe, the potato-based dough comprises around 0.2 wt % added sodium.

As outlined above, the starch component of the dough is the component that is primarily affected by reducing or eliminating the amount of added sodium. As the starch component is the main component of the dough, addressing the effect of sodium reduction on the starch component on bulk density and/or expansion by inclusion of a functional ingredient will lead to a pellet with better expansion properties (more closely resembling those of a standard added sodium pellet) regardless of what, if any, other components are included in the dough.

### Functional Ingredients

As outlined above, adding new ingredients to pellet doughs is usually avoided because the new ingredients can make undesirable changes to the textural properties of the resulting snack food products. Often, the new ingredients produce an expanded snack food product which is unrecognisable from the same products which do not contain the additional ingredient(s). Adding new ingredients is also generally avoided because it can increase the cost of manufacturing the expanded snack food product and/or can lead to labelling implications. It can also increase the manufacturing complexity of the pellets and the resulting snack food products. However, in this disclosure, it was surprisingly found that including a functional ingredient in the dough could result in reduced or zero added sodium pellets which expand upon cooking to produce well expanded snack food product with favourable textural properties in a cost effective manner and with no labelling implications.

In some embodiments, the functional ingredient is a plasticiser (or softener). A plasticiser is an ingredient which makes a dough plastic and less viscous. Examples of plasticisers include, but are not limited to pre-gelatinised starch, sugar, oils (vegetable oil, olive oil, nut oil etc), emulsifiers (mono- and di-glycerides, stearoyl lactylates, sorbitan esters, polyglycerol esters, sucrose esters, lecithin etc), sugar alcohols (mannitol, xylitol, erythritol, sorbitol, maltitol, isomalt, lactitol etc), and/or combinations thereof. In some embodiments, the functional ingredient is selected from the group consisting of pre-gelatinised starches, raising agents, acids, matrix modifiers, alternative salts, and combinations thereof. In some embodiments, the functional ingredient is selected from the group consisting of modified starches, pre-gelatinised starches, raising agents, acids, matrix modifiers, and combinations thereof.

In some embodiments, the functional ingredient is a modified starch. Modified starches include pre-gelatinised starch, chemically modified starch, cross-linked starch, enzyme modified starch, and/or combinations thereof.

In some embodiments, the functional ingredient is a pre-gelatinised starch. Pre-gelatinised starch is starch which has already been at least partially gelatinised. The gelatinisation is usually achieved by cooking and then drying the starch. The starch is usually provided as a dried flake or powder. Pre-gelatinised starches retain most of the functional properties and viscosity of the original base material. Pre-gelatinised starches are thought to be beneficial in the disclosed method because they have a plasticising effect on the matrix. The plasticising effect lower the glass transition temperature of pellets formed from the dough which in turn enables the pellets to start expanding at lower temperatures, enabling greater expansion compared to low sodium pellets at the same frying conditions. This in turn then produces expanded snack food products with decreased bulk density and, consequently, improved texture.

Any food quality pre-gelatinised starch may be used as the functional ingredient in the methods of the present disclosure. For example, the pregelatinised starch may be pre-gelatinised rice starch, potato starch, corn starch, wheat starch and/or tapioca starch. In preferred embodiments, the pre-gelatinised starch is rice starch and/or potato starch. In some embodiments, the rice starch is HerbaGEL™. In some embodiments, the potato starch is Paselli™.

In some embodiments, the dough comprises about 1 wt % to 10 wt % pre-gelatinised starch. Preferably, the dough comprises about 2 wt % to about 8 wt % pre-gelatinised starch, more preferably about 3 wt % to about 6 wt % pre-gelatinised starch, more preferably about 4 wt % to about 5 wt % pre-gelatinised starch.

In some embodiments, the dough comprises up to about 10 wt % pregelatinised starch, preferably up to about 9 wt %, or up to about 8 wt %, up to about 7 wt %, or up to about 6 wt % pregelatinised starch.

In some embodiments, the dough comprises at least about 1 wt % pregelatinised starch, preferably at least about 2 wt %, or at least about 3 wt %, or at least about 4 wt % pregelatinised starch.

In some embodiments, the functional ingredient is a raising agent. A raising agent is a substance added to a food product, such as a dough to make it rise. Any food quality raising agent may be used as the functional ingredient in the methods of the present disclosure. In some embodiments, the raising agent may be sodium bicarbonate, yeast, potassium bicarbonate and/or combinations thereof. In some embodiments, the raising agent is sodium bicarbonate.

In some embodiments, the dough comprises about 0.1 wt % to about 2.5 wt % raising agent, preferably about 0.2 wt % to about 2.0 wt %, more preferably about 0.3 wt % to about 1.5 wt %, still more preferably about 0.4 wt % to about 1.0 wt %.

In some embodiments, the dough comprises up to about 2.4 wt % raising agent. Preferably, the dough comprises up to about 2.0 wt % raising agent, or up to about 1.5 wt %, or up to about 1.0 wt % raising agent.

In some embodiments, the dough comprises at least about 0.1 wt % raising agent. Preferably, the dough comprises at least about 0.2 wt % raising agent, or at least about 0.3 wt %, or at least about 0.4 wt % raising agent. Most preferably, the dough comprises about 0.5 wt % raising agent.

The dough may comprise an acid as the functional ingredient. The acid may be any food quality acid. Suitable acids include, but are not limited to citric acid, acetic acid, fumaric acid, lactic acid, phosphoric acid, malic acid, tartaric acid and/or combinations thereof. In preferred embodiments, the acid is selected from citric acid and phosphoric acid. Preferably the phosphoric acid is monocalcium phosphate.

In some embodiments, the dough comprises about 0.2 wt % to about 1.0 wt % of acid. Preferably, the dough comprises about 0.3 wt % to about 0.8 wt % acid, more preferably about 0.4 wt % to about 0.7 wt % acid.

In some embodiments, the dough comprises up to about 1.0 wt % acid. Preferably, the dough comprises up to about 0.8 wt % acid, or up to about 0.7 wt % acid. In some embodiments, the dough comprises about 0.6 wt % acid.

In some embodiments, the dough comprises at least about 0.2 wt % acid. Preferably, the dough comprises at least about 0.2 wt % acid, or about 0.3 wt % acid. In some embodiments, the dough comprises about 0.5 wt % acid.

In some embodiments, the functional ingredient comprises an acid and a raising agent. In these embodiments, the acid and raising agent are preferably included at a (molar) ratio of about 1:2.0 to 1:3.0, more preferably about 1:2.5.

It is hypothesised that using a raising agent and an acid as functional ingredients is beneficial because both water and carbon dioxide are generated when the acid & raising agent (alkali) react. The water helps with hydration of the starch granules which makes it easier for the starch to gelatinise, and the carbon dioxide forms bubbles in the pellet matrix which are then points of nucleation when the pellet is expanded.

In some embodiments, the functional ingredient is an alternative salt. The alternative salt is any food grade salt which is not sodium chloride. In some embodiments, the alternative salt is selected from the group consisting of potassium chloride, magnesium chloride, potassium sulphate, sodium acetate, tetrasodium pyrophosphate, flavoured salts and combinations thereof. In some embodiments, the combination of alternative salts may be Boulder Salt™ (https://www.bouldersaltcompany.com/) or Kosher salt (e.g. by Diamond Crystal Kosher Salt| Diamond Crystal® Salt (diamondcrystalsalt.com))

It is hypothesised that alternative salts work in a similar way to sodium chloride in the role they play in the expansion mechanism of the pellets during cooking. It is thought that, as for sodium chloride, alternative salts have several roles, including modifying the moisture distribution, holding on to water within the pellet, lowering the glass transition temperature (T_{g}), acting as nucleation sites for expansion, increasing the expansion ratio and/or modifying the rheological properties of the matrix.

In some embodiments, the alternative salt is potassium chloride.

In some embodiments, the functional ingredient is a matrix modifier. A matrix modifier is . . . is an ingredient that changes one or more properties of the disintegrated starch matrix, these properties include the glass transition temperature, tensile strength etc. The term “matrix modifier” summarises many different phenomena including plasticization, where water is held, the way the matrix is disrupted etc.

In some embodiments, the matrix modifier is oil (vegetable oil, olive oil, nut oil etc), emulsifiers (mono- and di-glycerides, stearoyl lactylates, sorbitan esters, polyglycerol esters, sucrose esters, lecithin etc), sugar, maltodextrins, sugar alcohols (mannitol, xylitol, erythritol, sorbitol, maltitol, isomalt, lactitol etc), and/or combinations thereof.

In preferred embodiments, the matrix modifier is sugar (sucrose).

In some embodiments, the dough comprises about 1.0 wt % to about 10 wt % matrix modifier. Preferably, the dough comprises about 1.5 wt % to about 7.5 wt % matrix modifier, or about 2.0 wt % to about 5.0 wt.

In some embodiments, the dough comprises up to about 10 wt % matrix modifier. Preferably, the dough comprises up to about 7.5 wt %, or up to about 5.0 wt % matrix modifier.

In some embodiment, the dough comprises at least about 1.0 wt % matric modifier. Preferably, the dough comprises at least about 1.5 wt %, or at least about 2.0 wt % matrix modifier. In particularly preferred embodiments, the dough comprises about 3.0 wt % matrix modifier.

### Pellet Properties

Including a functional ingredient in the dough used to manufacture a reduced or zero added sodium expandable snack food pellet according to the present disclosure may produce a pellet with properties approaching those of a standard added sodium pellet. For example:

### Expansion Ratio

As discussed above, it is desirable to manufacture a reduced or zero added sodium pellet which has an expansion ratio closely resembling that of a standard added sodium pellet. Therefore, in some embodiments, there is provided a reduced or zero added sodium expandable snack food pellet comprising less than about 300 mg added sodium per 100 g of pellets, wherein the pellet has an expansion ratio which is about ±5% of the expansion ratio of a standard pellet not comprising the functional ingredient.

Expansion ratio is the volume ratio between the dried pellet and the expanded snack food. Expansion ratio can be determined by volumetric (displacement) measurement.

Typically, a standard added sodium pellet has an expansion ratio of about 3 to about 8. When a reduced or zero added sodium is prepared (with no functional ingredient) under the same manufacturing conditions as a standard sodium pellet (i.e. under standard conditions), the expansion ratio decreases to about 1.2 to about 5. This leads to a poorly expanded product which has a texture that is undesirable to consumers.

When the reduced or zero added sodium pellets are manufactured from a dough comprising a functional ingredient, the expansion ratio increases to about 3 to about 6. As this is within the range of expansion ratio of the standard added sodium pellet, the reduced or zero added sodium expanded snack food product much more closely resembles that produced from a standard sodium pellet and has better textural characteristics.

In some embodiments therefore, including a functional ingredient in a reduced or zero added sodium pellet dough increases the expansion ratio such that the reduced or zero added sodium pellet has a higher expansion ratio than the same pellet (i.e. a reduced or zero added sodium pellet) which does not comprise the functional ingredient.

In some embodiments there is provided a reduced or zero added sodium expandable snack food pellet comprising less than about 300 mg added sodium per 100 g of pellets and functional ingredient, wherein the pellet has an expansion ratio of about 3 to about 6, preferably about 4 to about 5.

In some embodiments, the pellet has an expansion ratio of up to about 6, preferably up to about 5. It can also be said that the pellet has an expansion ratio of at least about 3, or at least about 4.

### Glass Transition Temperature

The glass transition temperature of the dough T_{g} is an important measure that correlates to dough stiffness/flexibility. The glass transition temperature is an indicator of where the material begins to demonstrate flow; or alternately where a plastic, flexible material is beginning to acquire more solid like behaviour. The glass transition temperature is an indicator of where the change in material properties begins. In general, the higher T_{g} is inversely related to dough flexibility. Therefore, as the amount of added sodium is reduced and the glass transition temperature increases, so the rheological strength of the matrix increases. The matrix become stiffer leading to poorer expansion.

The glass transition temperature can be determined by any means suitable. For example by dynamic mechanical analysis (DMA), in particular DMA-7 using a Perkin-Elmer three-point blending test. This analysis uses a heating rate of 10° C. per minute, a temperature scan of 25-150° C., a Constant Stress Frequency of 1 Hz and a PTFE sheet.

A standard added sodium pellet typically has a T_{g} of about 55 to about 80° C. When a reduced or zero added sodium is prepared (with no functional ingredient) under the same manufacturing conditions as a standard sodium pellet (i.e. under standard conditions), the T_{g} increases to about 80 to about 125° C. This in turn increases the rheological strength of the matrix which leads to poor expansion and provides a final product which has a texture that is hard, crunchy and dense.

When the reduced or zero added sodium pellets are manufactured from a dough comprising a functional ingredient, the T_{g} of the pellet is reduced to less than about 80° C., preferably less than about 70° C., more preferably, between about 60° C. and about 75° C. As this is within the range of T_{g} of the standard added sodium pellet, the reduced or zero added sodium expanded snack food product much more closely resembles that produced from a standard added sodium pellet and has better textural characteristics.

In some embodiments therefore, including a functional ingredient in a reduced or zero added sodium pellet dough lowers the glass transition temperature such that the reduced or zero added sodium pellet has a lower glass transition temperature than the same pellet (i.e. a reduced or zero added sodium pellet) which does not comprise the functional ingredient. In some embodiments therefore, there is provided a reduced or zero added sodium expandable snack food pellet comprising less than about 300 mg added sodium per 100 g of pellets and a functional ingredient, wherein the pellet has a glass transition temperature of less than about 80° C., preferably less than about 75° C., more preferably less than about 70° C.

It can alternatively be said that there is provided a reduced or zero added sodium expandable snack food pellet comprising less than about 300 mg added sodium per 100 g of pellets and a functional ingredient, wherein the pellet has a glass transition temperature of up to about 80° C., preferably up to about 75° C., more preferably up to about 70° C.

### Tensile Strength

Tensile strength is defined as the “resistance to lengthwise stress, measured by the greatest load in weight per unit area pulling in the direction of length that a given substance can bear without tearing apart”. Removal of sodium from a pellet leads to an increase rheological strength of the matrix and, in turn, an increase in tensile strength. It is anticipated that including a functional ingredient in the dough of a reduced or low added sodium pellet will decrease the tensile strength towards a value of a standard sodium pellet. It is hypothesised that this is because the functional ingredient changes the overall matrix properties which in turn will decrease the tensile strength of a reduced or low added sodium pellet.

The tensile strength can be determined by any means suitable, for example using Instron Universal Testing Machine (5.500R6025), Instron Oven Tensile tests at high temperatures 100° C., 6 mm/min, 5 replicates/recipe.

A standard sodium pellet typically has a tensile strength of about 0.8 to about 4.5 MPa. When a reduced or zero added sodium is prepared under the same manufacturing conditions as a standard sodium pellet (i.e. standard conditions), the tensile strength increases to about 1 to about 12 MPa. This in turn increases the rheological strength of the matrix which leads to poor expansion and provides a final product which has a texture that is hard, crunchy and dense.

### Modulus

Modulus, or the tensile modulus, evaluates the elasticity of a material and the power needed to deform it. It measures stiffness of a material. Removal of sodium from a pellet leads to an increase rheological strength of the matrix and, in turn, an increase in tensile modulus. As for tensile strength above, it is anticipated that including a functional ingredient in the dough of a reduced or zero added sodium pellet dough will decrease the tensile modulus towards a value of a standard added sodium pellet.

The modulus can be determined by any suitable means. For example, using Instron Universal Testing Machine (5.500R6025), Instron Oven Tensile tests at high temperatures 100° C., 6 mm/min, 5 replicates/recipe.

A standard added sodium pellet typically has a modulus of about 40 to about 140 MPa. When a reduced or zero added sodium is prepared under the same manufacturing conditions as a standard sodium pellet (i.e. standard conditions), the tensile strength increases to about 100 to about 240 MPa. This in turn increases the rheological strength of the matrix which leads to poor expansion and provides a final product which has a texture that is hard, crunchy and dense.

### Time to Expansion

Time to expansion refers to the time taken between the pellets being subjected to cooking conditions (generally frying) and the time to when expansion begin (initial bubble formation). Removal of sodium from a pellet leads to an increased time to expansion. It is thought that this is because, as sodium is removed and the rheological strength of the matrix increases, the matrix become stiffer. A stiffer matrix has an increased brittle-ductile transition temperature meaning more energy is required to expand the product. The matrix therefore requires more heating to reach the point where it is ductile enough to expand. This equates to an increased time to expansion.

There is no standardised way to measure time to expansion, it is typically determined by recording the frying of the pellet and making a visual judgement on when expansion begins.

A standard added sodium pellet typically has a time to expansion of about 25 to about 40 seconds (at a measurement temperature of about 130° C. to about 150° C.). When a reduced or zero added sodium is prepared under the same manufacturing conditions as a standard added sodium pellet (i.e. standard conditions), the time to expansion increases to about 90 seconds (at a measurement temperature of about 130° C. to about 150° C.).

### Expanded Snack Food Properties

Including a functional ingredient in the dough used to manufacture a reduced or zero added sodium expandable snack food pellet according to the present disclosure may result in the production of an expanded snack food with properties approaching those of a standard added sodium expanded snack food. For example:

### Bulk Density

As discussed above, it is desirable to manufacture a reduced or zero added sodium expanded snack food which has a bulk density closely resembling that of a standard added sodium expanded snack food. Therefore, in some embodiments, there is provided a reduced or zero added sodium expanded snack food comprising less than about 300 mg added sodium per 100 g of snack food and a functional ingredient, wherein the snack food has a bulk density which is about ±5% of the bulk density of a standard snack food not comprising the functional ingredient.

When sodium is removed from (or not added to) a pellet, the bulk density of the expanded snack food produced from the pellet increases. This is undesirable because a denser expanded snack food has a texture that is hard, crunchy and dense.

Bulk density can be measured by placing the product into a 5 L transparent plastic beaker until full and allowing the product of the beaker to settle. The weight of the product is then recorded and the bulk density is calculated by dividing the weight (g) by the volume (L).

Typically, a standard added sodium expanded snack food has a bulk density of about 35 to about 70 g/L. When a reduced or zero added sodium pellet is prepared (with no functional ingredient) under the same manufacturing conditions as a standard sodium pellet (i.e. under standard conditions), the bulk density of the resulting expanded snack food increases to about 50 to about 80 g/L. This leads to a product which has a texture that is undesirable to consumers.

When the reduced or zero added sodium pellets are manufactured from a dough comprising a functional ingredient, the bulk density of the resulting expanded snack food decreases to about 40 to about 60 g/L, preferably, about 45 to about 55 g/L. As this is within the range of bulk density of the standard added sodium expanded snack food, the reduced or zero added sodium expanded snack food product much more closely resembles that produced from a standard sodium pellet and has better textural characteristics.

In some embodiments therefore, including a functional ingredient in a reduced or zero added sodium pellet dough decreases the bulk density such that the reduced or zero added sodium expanded snack food has a lower bulk density than the same expanded snack food (i.e. a reduced or zero added sodium snack food) which does not comprise a functional ingredient.

In some embodiments there is provided a reduced or zero added sodium expanded snack food comprising less than about 300 mg of added sodium per 100 g of snack food and a functional ingredient, wherein the expanded snack food has a bulk density of about 40 g/L to about 60 g/L, preferably about 45 g/L to about 55 g/L.

In some embodiments, the expanded snack food has an bulk density of less than about 60 g/L, preferably about 50 g/L.

### Post Extrusion

Once the extrudate has been produced, it is formed into pellets. This may be undertaken by any method known in the art and the pellets may take any desired shape and/or configuration.

The pellets are then dried. The pellets may be dried by any technique used to dry standard pellets. Typical conditions for drying are 45° C., 65% humidity for 5 hours.

The dried pellets may be expanded during a cooking step to produce a reduced or zero added sodium expanded snack food. The pellets may be expanded by any method known in the art. In some embodiments, the cooking step comprises frying, baking, microwaving or popping. These pellet expansion methods would be known to persons skilled in the art of snack food manufacture.

In some embodiments therefore, there is provided a method of producing a reduced or zero added sodium expanded snack food, comprising providing a plurality of reduced or zero added sodium snack food pellets as described herein; and expanding the pellets during a cooking step to produce an expanded snack food; optionally wherein the cooking step comprises frying, baking, microwaving or popping.

In some cases, it is possible to gain an additional improvement in the texture of the reduced or zero added sodium snack food products by frying the pellets under optimised conditions. It has surprisingly been found that increasing the frying temperature by about 5° C. to about 20° C. when frying reduced or low added sodium pellets relative to the temperature used to fry standard added sodium pellets can result in an expansion ratio, bulk density and product texture that is comparable to standard added sodium snack food products. This was unexpected because increasing the frying temperature for a standard added sodium pellet would be expected to cause browning/burning of the pellets, form process contaminants (acrylamide) and lead to oil quality deterioration.

### EXAMPLES

The following examples are specific embodiments of the present invention but are not intended to limit the present invention.

### Example 1

The impact of including 5% pre-gelatinised starch on the bulk density of expanded snack food resulting from pellets was investigated.

A standard sodium containing dough was prepared comprising 68% potato flake, 30% potato starch and 2% sodium chloride. The dough contained 787 mg of added sodium per 100 g of dough.

A reduced added sodium containing dough was also prepared comprising 69.8% potato flakes, 30% potato starch and 0.2% sodium chloride. The reduced added sodium dough contained 79 mg of added sodium per 100 g of dough. A reduced added sodium and functional ingredient containing dough was prepared. The functional ingredient was a pre-gelatinised rice flour. The pre-gelatinised rice flour was Pregelatinized gluten free rice flour HerbaGEL M350HCV obtained from S&B Herba. The dough was prepared comprising 64.8% potato flakes, 30% potato starch, 5% HerbaGEL M350HCV and 0.2% sodium chloride.

Each of the three doughs were extruded under the following extruder conditions:

| | |
|---|---|
| Extruder Temperature (° C.) | 80 |
| Extruder Speed (rpm) | 50 |
| Extruder Dough Moisture (%) | 32 |
| Pellet Moisture (%) | 11 ± 1 |

The extrudate was formed into pellets and the pellets were dried. The pellets where then fried at 185° C. for 15 seconds to produce expanded snack food products.

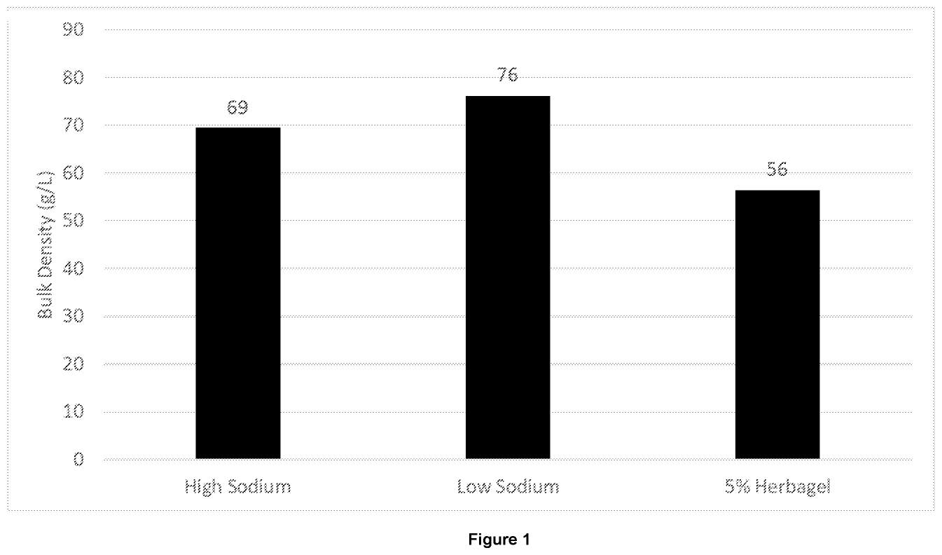

FIG. 1 shows the results of this example. The bulk density of expanded snack food products resulting from the standard sodium containing dough (“high sodium” in FIG. 1) was 69 g/L. This resulted in snack food products which had a texture that is desirable to consumers. It can be seen from FIG. 1 that simply reducing the amount of sodium in the dough led to a 10% increase in bulk density of the resulting snack food products (“low sodium” in FIG. 1) to 76 g/L. These products had a texture that was hard, crunchy and dense, and undesirable to consumers. However, adding 5% of a functional ingredient that is a pre-gelatinised starch (HerbaGEL M350HCV) decreased the bulk density of the expanded snack food product by 26% relative to the same snack food manufactured from the dough which does not comprise the functional ingredient (“low sodium”). The inclusion of 5% HerbaGEL also produced a snack food product with bulk density that was −18.8% of the bulk density of the bulk density of the snack food produced from the standard sodium containing dough (“high sodium”). The reduced sodium snack food products comprising HerbaGEL had a good texture which was not hard, crunchy or dense and was desirable to consumers.

### Example 2

Using the three pellets prepared in Example 1, the impact of adding 5% of a pre-gelatinised starch functional ingredient on the glass transition temperature of the resulting pellets was investigated.

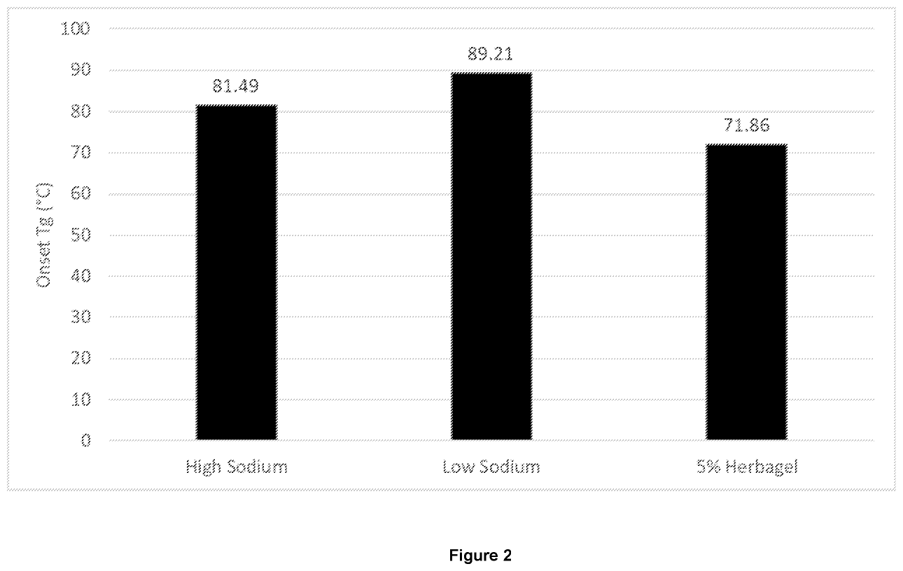

FIG. 2 show the results of this Example. Pellets from the standard sodium continuing dough (“high sodium”) had a glass transition temperature of 81.49° C. It can be seen that simply reducing the amount of added sodium in the dough increases the glass transition temperature of the resulting pellets by 9.5% to 89.21° C. (“low sodium”). However, including 5% HerbaGEL in the dough has the effect of decreasing the glass transition temperature of the resulting pellets by 19.4% relative to the same pellet manufactured from the dough which does not comprise the functional ingredient (“low sodium”). The inclusion of 5% HerbaGEL also produced pellets with a glass transition temperature within 11.8% of the glass transition temperature of the pellets produced from the standard sodium containing dough (“high sodium”).

It is hypothesised that the reduction in glass transition temperature in the pellets comprising HerbaGEL is due to the plasticizing impact of the HerbaGEL on the matrix. The lower glass transition temperature of the HerbaGEL containing pellets, enables the pellets to start expanding at lower temperatures, enabling greater expansion compared to low sodium pellets at the same frying conditions (185° C., 15 seconds). This in turn then produces expanded snack food products with decreased bulk density and, consequently, improved texture.

### Example 3

The impact of adding 5% of a pre-gelatinised starch functional ingredient on the expansion ratio of the resulting pellets was investigated.

The three doughs prepared in Example 1 were extruded under the following conditions:

| | |
|---|---|
| Extruder Temperature (° C.) | 60 |
| Extruder Speed (rpm) | 60 |
| Extruder Dough Moisture (%) | 36 |
| Pellet Moisture (%) | 10.5 ± 1 |

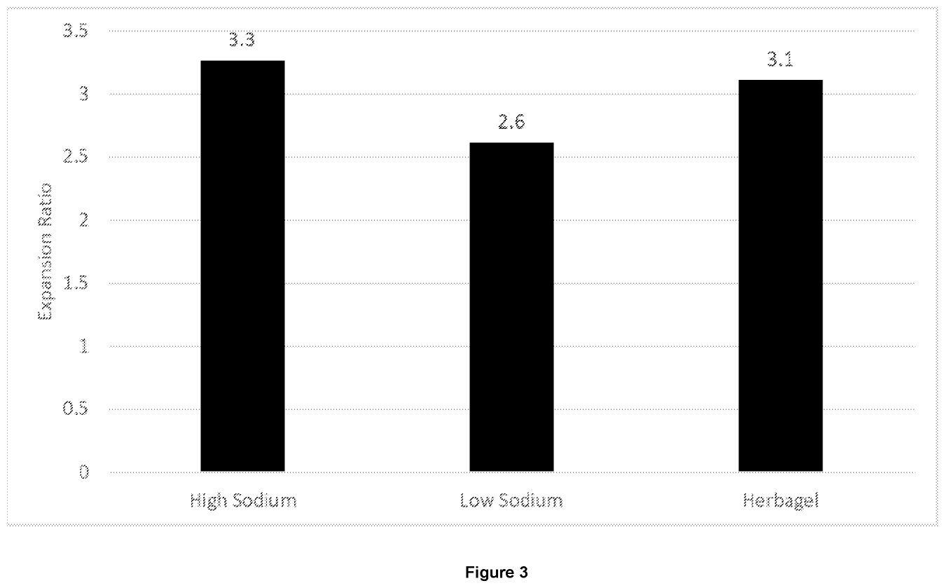

FIG. 3 shows the results of this Example. Pellets from the standard sodium continuing dough (“high sodium”) had an expansion ratio of 3.3. It can be seen that simply reducing the amount of added sodium in the dough decreases the expansion ratio of the resulting pellets by 21.2% to 2.6 (“low sodium”). However, including 5% HerbaGEL in the dough has the effect of increasing the expansion ratio of the resulting pellets by 19.2% relative to the same pellet manufactured from the dough which does not comprise the functional ingredient (“low sodium”). The inclusion of 5% HerbaGEL also produced pellets with an expansion ratio that is within 6.1% of the expansion ratio of the pellets produced from the standard sodium containing dough (“high sodium”).

### Example 4

The impact of including an acid and a raising agent on the bulk density of expanded snack food resulting from pellets was investigated.

A standard sodium containing dough was prepared comprising 96% wheat flour, 1% sodium bicarbonate and 3% sodium chloride. The dough contained 1455 mg of added sodium per 100 g of dough.

A reduced added sodium containing dough was also prepared comprising 99.24% wheat flour, 0.49% sodium bicarbonate and 0.27% sodium chloride. The reduced added sodium dough contained 250 mg of added sodium per 100 g of dough.

Two reduced added sodium and functional ingredient containing doughs were prepared. Both doughs contained an acid (and a raising agent) as the functional ingredient. The first dough contained monocalcium phosphate (MCP) and the dough comprised 98.63% wheat flour, 0.49% sodium bicarbonate, 0.27% sodium chloride and 0.61% MCP. The (molar) ratio of acid:raising agent was 1:2.23. The second dough comprised citric acid and the dough comprised 98.77% wheat flour, 0.49% sodium bicarbonate, 0.27% sodium chloride and 0.47% citric acid. The (molar) ratio of acid:raising agent was 1:2.38.

Each of the four doughs were extruded under the following extruder conditions:

| | |
|---|---|
| Extruder Temperature (° C.) | 100 |
| Extruder Speed (rpm) | 100 |
| Extruder Dough Moisture (%) | 32 |
| Pellet Moisture (%) | 11.5 ± 1.2 |

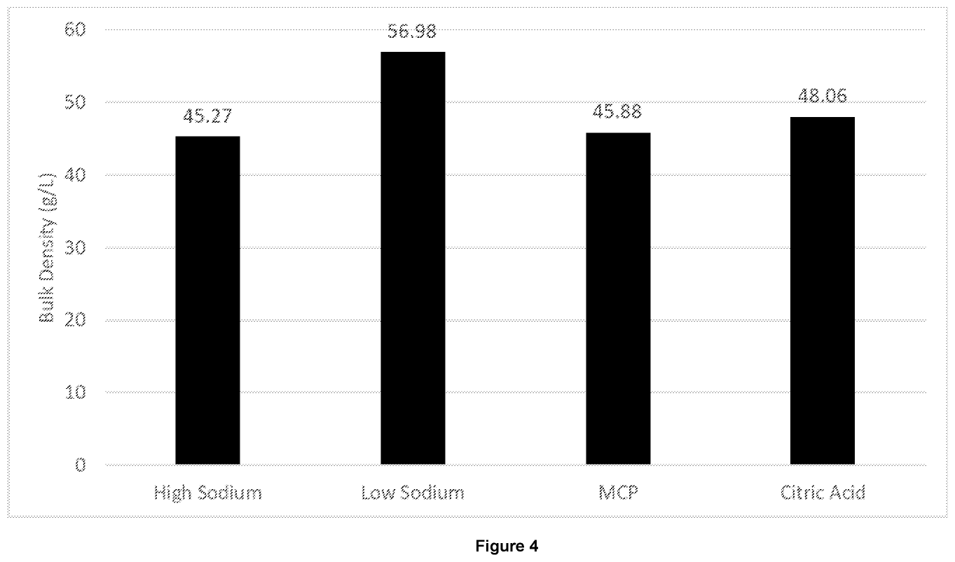

FIG. 4 shows the results of this example. Bulk density of expanded snack food products resulting from the standard sodium containing dough (“high sodium”) was 45.27 g/L. This resulted in snack food products which had a texture that is desirable to consumers. It can be seen from FIG. 4 that, as before, simply reducing the amount of sodium in the dough led to a 25.9% increase in bulk density of the resulting snack food products (“low sodium” in FIG. 4) to 56.98 g/L. Again, these products had a texture that was hard, crunchy and dense, and undesirable to consumers.

Adding 0.61% of MCP to the dough decreased the bulk density of the resulting expanded snack food product by 19.5% relative to the same snack food manufactured from the dough which does not comprise the functional ingredient (“low sodium”). The addition of MCP also resulted in a snack food product that had a bulk density within 1.3% of the bulk density of the snack food produced from the standard sodium containing dough (“high sodium”). The reduced sodium snack food products comprising MCP had a good texture which was not hard, crunchy or dense and was desirable to consumers.

Adding 0.47% citric acid to the dough had a similar effect to the MCP. The bulk density of the resulting expanded snack food product was reduced by 15.7% relative to the same snack food manufactured from the dough which does not comprise the functional ingredient (“low sodium”). The addition of citric acid resulted in a snack food product that had a bulk density within 6.2% of the bulk density of the snack food produced from the standard sodium containing dough (“high sodium”). The reduced sodium snack food products comprising citric acid had a good texture which was not hard, crunchy or dense and was desirable to consumers.

### Example 5

The impact of including an acid and a raising agent on bulk density of the expanded snack food resulting from pellets was investigated.

A standard sodium containing dough was prepared comprising 94% maize flour, 2% sodium bicarbonate, 3% sugar (sucrose) and 1% sodium chloride. The dough contained 940 mg of added sodium per 100 g of dough.

A reduced added sodium containing dough was also prepared comprising 96.25% maize flour, 0.5% sodium bicarbonate, 3% sugar (sucrose) and 0.25% sodium chloride. The dough contained 235 mg of added sodium per 100 g of dough.

A reduced added sodium and an acid functional ingredient containing dough was prepared. The dough comprised 95.78% wheat flour, 0.5% sodium bicarbonate, 3% sugar (sucrose), 0.25% sodium chloride and 0.47% citric acid. The ratio of acid:raising agent was 1-2.5.

Each of the three doughs were extruded under the following extruder conditions:

| | |
|---|---|
| Extruder Temperature (° C.) | 100 |
| Extruder Speed (rpm) | 90 |
| Extruder Dough Moisture (%) | 36 |
| Pellet Moisture (%) | 10 ± 1 |

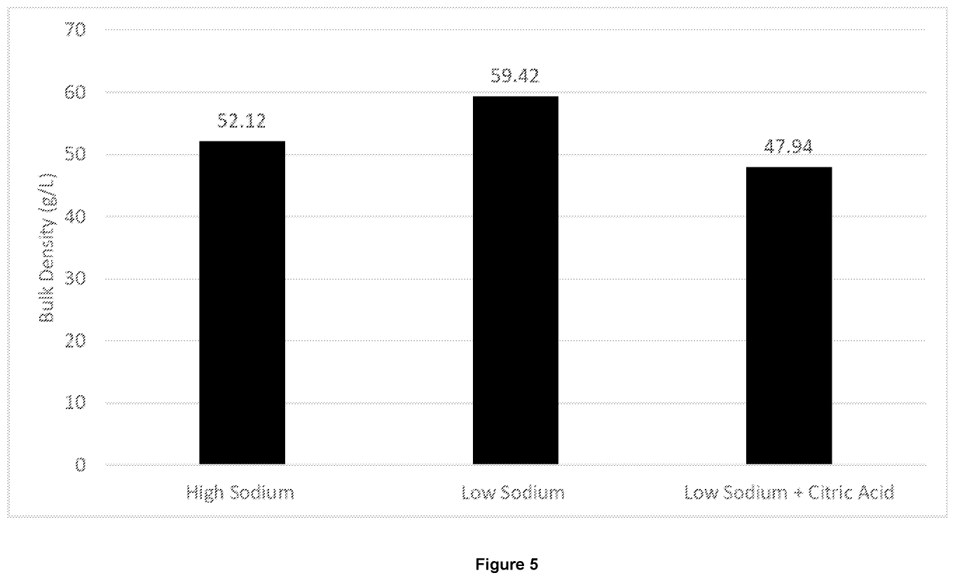

FIG. 5 shows the results of this example. Bulk density of expanded snack food products resulting from the standard sodium containing dough (“high sodium”) was 52.12 g/L. This resulted in snack food products which had a texture that is desirable to consumers. It can be seen from FIG. 5 that, as before, simply reducing the amount of sodium in the dough led to a 14% increase in bulk density of the resulting snack food products (“low sodium” in FIG. 5) to 59.42 g/L. Again, these products had a texture that was hard, crunchy and dense, and undesirable to consumers.

Including an acid in the dough, in addition to the raising agent so a decrease in the bulk density of the resulting expanded snack food product by 19.3% relative to the same snack food manufactured from the dough which does not comprise the acid (“low sodium”). The addition of citric acid resulted in a snack food product that had a bulk density within 8.0% of the bulk density of the snack food produced from the standard sodium containing dough (“high sodium”). The reduced sodium snack food products comprising citric acid had a good texture which was not hard, crunchy or dense and was desirable to consumers.

### Example 6

The impact of sugar as a functional ingredient on the glass transition temperature of a zero added sodium potato pellet was investigated.

A standard sodium containing dough was prepared comprising 67.9% potato flake, 29.1% potato starch and 3% sodium chloride. The dough contained 1181 mg of added sodium per 100 g of dough.

A zero added sodium containing dough was also prepared comprising 70% potato flake and 30% potato starch. The dough contained 0 mg of added sodium per 100 g of dough.

A zero added sodium dough containing a sugar functional ingredient was prepared. The dough comprised 67.9% potato flakes, 29.1% potato starch and 3% sugar (sucrose).

Each of the three doughs were extruded under the following extruder conditions:

| | |
|---|---|
| Extruder Temperature (° C.) | 80 |
| Extruder Speed (rpm) | 70 |
| Extruder Dough Moisture (%) | 36 |
| Pellet Moisture (%) | 11 ± 1 |

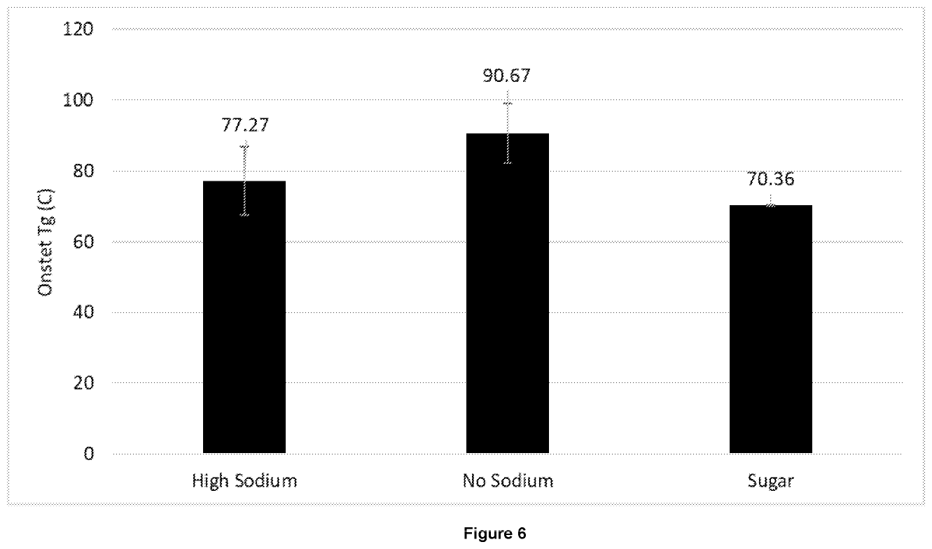

FIG. 6 shows the results of this example. Pellets from the standard sodium continuing dough (“high sodium”) had a glass transition temperature of 77.27° C. It can be seen that simply reducing the amount of added sodium in the dough increases the glass transition temperature of the resulting pellets by 17.3% to 90.67° C. (“low sodium”). However, including 3% sugar in the dough has the effect of decreasing the glass transition temperature of the resulting pellets by 22.4% relative to the same pellet manufactured from the dough which does not comprise the functional ingredient (“low sodium”). The inclusion of 3% sugar also produced pellets with a glass transition temperature within −8.9% of the glass transition temperature of the pellets produced from the standard sodium containing dough (“high sodium”).

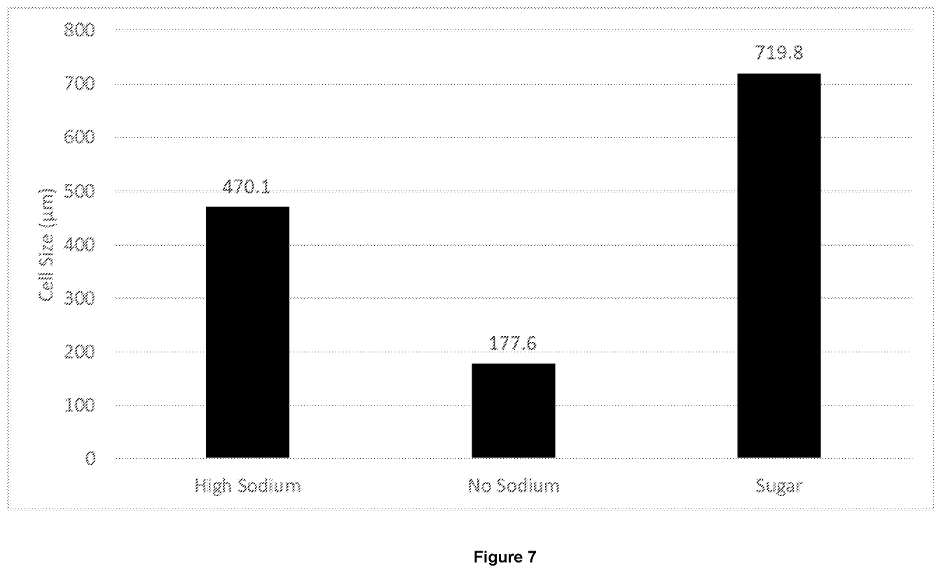

It was discovered that there was also a measurable impact on the microstructure (cell size) of each of these formulations. FIG. 7 shows this impact. Removal of sodium from the dough results in a dramatic cell size reduction in the expanded snack food product, with the zero added sodium product (“no sodium”) having an average cell size of around 177 microns (reduced from 470 microns for the standard “high sodium” product). By adding 3% sugar to the zero added sodium dough, the cell size is recovered due to the degeneration in the structure and the presence of bigger cells.

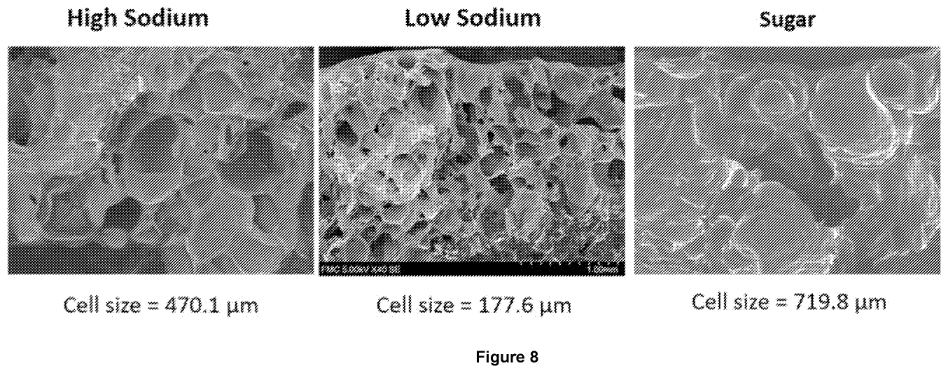

FIG. 8 shows SEM micrographs showing the cell sizes of expanded snack food products produced from each of the standard dough, the zero added sodium dough and the zero added sodium dough comprising sugar. These three products show vastly different microstructures.

It is hypothesised that by adding a smaller amount of sugar, the sugar containing formulation could have a similar average cell size to that of the high sodium reference.

For the avoidance of any doubt, the terms “a”, “an” and “the” are intended, unless specifically indicated otherwise or the context requires otherwise, to include plural alternatives, e.g., at least one.

“Optional” or “optionally” means that the subsequently described event or circumstance can or cannot occur, and that the description includes instances where the event or circumstance occurs and instances where it does not.

Various other modifications to the present invention will be readily apparent to those skilled in the art.

1. A method for manufacturing a reduced or zero added sodium expandable snack food pellet comprising:
determining a reference dough comprising less than 300 mg of added sodium per 100 g of dough and no functional ingredient;
providing a dough that is identical to the reference dough except that it comprises a functional ingredient;
extruding the dough through an extruder to produce an extrudate;
forming the extrudate into pellets; and
drying the pellets to produce a snack food pellet that has an expansion ratio, when cooked by frying, baking, microwaving or popping, that is 5% to 40% greater than a same pellet produced from the reference dough in the same way and cooked by a same method;
wherein the functional ingredient is selected from the group consisting of pre-gelatinized starch, raising agent, acid, or alternative salts selected from the group consisting of magnesium chloride, potassium sulphate, sodium acetate, tetrasodium pyrophosphate, and combinations thereof, and combinations thereof; and wherein the dough comprises, as the functional ingredient, 2 wt % to 8 wt % pre-gelatinized starch, or 0.1 wt % to 2.5 wt % raising agent, or 0.2 wt % to 1.0 wt % acid, or alternative salts selected from the group consisting of magnesium chloride, potassium sulphate, sodium acetate, tetrasodium pyrophosphate, and combinations thereof and combinations thereof.

2.-4. (canceled)

5. The method according to claim 1, wherein the dough comprises about 2 wt % to 8 wt % of pre-gelatinised starch, preferably wherein the pre-gelatinised starch is a pre-gelatinised rice flour.

6. The method according to claim 1, wherein the acid is monocalcium phosphate and/or citric acid.

7. (canceled)

8. The method according to claim 1, wherein the raising agent is sodium bicarbonate.

9. (canceled)

10. The method according to claim 1, wherein the functional ingredient comprises an acid and a raising agent at a ratio of about 1:2.0 to 1:3.0.

11. The method according to claim 1, wherein the dough comprises less than about 250 mg of added sodium per 100 g of dough.

12. The method according to claim 1, wherein the dough comprises zero added sodium per 100 g of dough.

13. A method for manufacturing a reduced or zero added sodium expandable snack food pellet comprising:
determining a reference dough for manufacturing a standard added sodium pellet, the reference dough comprising at least 950 mg of added sodium per 100 g of dough and no functional ingredient
providing a dough that is identical to the reference dough except that it comprises less than about 300 mg of added sodium per 100 g of dough and a functional ingredient;
extruding the dough through an extruder to produce an extrudate;
forming the extrudate into pellets; and
drying the pellets to produce a snack food pellet that has an expansion ratio, when cooked by frying, baking, microwaving, or popping, which is about ±10%, of the expansion ratio of a same pellet produced from the reference dough in the same way and cooked by a same method;
wherein the dough comprises, as the functional ingredient, 2 wt % to 8 wt % pre-gelatinized starch, or 0.1 wt % to 2.5 wt % raising agent, or 0.2 wt % to 1.0 wt % acid, or alternative salts selected from the group consisting of magnesium chloride, potassium sulphate, sodium acetate, tetrasodium pyrophosphate, and combinations thereof, and combinations thereof.

14.-19. (canceled)

20. A method of manufacturing a reduced or zero added sodium expanded snack food, comprising:
manufacturing a plurality of reduced or zero added sodium expandable snack food pellets according to claim 1; and
expanding the pellets during a cooking step to produce an expanded snack food; optionally wherein the cooking step comprises frying, baking, microwaving or popping.

21. (canceled)

22. (canceled)
